(19) United States
(12) Patent Application Publication
(10) Pub. No.: US 2005/0240920 A1
(43) Pub. Date: Oct. 27, 2005

(54) Installation control program, installation method and installation apparatus therefor

(75) Inventors: Osamu Yoshimura, Nagoya (JP); Yasuo Fujita, Kawasaki (JP); Yasuo Isoda, Kawasaki (JP); Noriyuki Nakagami, Minato-ku (JP); Yasuo Miyata, Minato-ku (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/044,202

(22) Filed: Jan. 28, 2005

(30) Foreign Application Priority Data
Apr. 22, 2004 (JP) 2004-126957

(51) Int. Cl. G06F 9/445

(52) U.S. Cl. 717/174

(57) ABSTRACT

Conventionally, there exists a problem of incurring suspicion of a customer, if a demonstration is performed under a mismatch condition between an implemented state of a certain function in a personal computer and actual availability of the function. Therefore a program is provided executed by a computer capable of executing a first program and a second program including the steps of performing an execution decision procedure for deciding whether the first program can be executed normally, and performing an installation procedure for installing the second program, when the first program is decided to be executable normally in the decision procedure.

### BACKGROUND OF THE INVENTION

1. Field of the Invention

The present invention relates to an installation control program (installer) for installing application programs into a computer, and more particularly an installer for selectively introducing a demonstration program for execution, to show the functions of a personal computer exhibited to customers at the store.

2. Description of the Related Art

At present, when a personal computer (PC) is displayed at the store for sale, demonstration programs are executed to show the features and the functions of the PC, model by model, for customers' easy understanding. The demonstrations presented to the customers by executing the demonstration programs include: displaying a message to emphasize high performance, such as high arithmetic capability or high resolution of a liquid crystal display; stressing to the customers a built-in TV view function by actually displaying on the screen, and by explaining an operation method using a moving picture; and stressing a function for creating an original DVD (digital versatile disk) by explaining, using a moving picture, a method and procedure to use DVD creation software.

Each demonstration program functions as a screen saving mechanism (screen saver). Namely, when PC operation is not performed for a certain period, the demonstration is started automatically. After that, when the customer operates the PC, the demonstration is suspended. Again, if the PC operation is not performed for a certain period, the demonstration is resumed. Thus, both the demonstration and the customer operation can be performed compatibly, and efficient switchover is performed.

Such demonstration programs are installed into the PC, prior to exhibition at the store, depending on the hardware provided in the PC and the preinstalled software.

As preceding techniques, in the official gazettes of the Japanese Unexamined Patent Publication No. 2000-75985, there is disclosed a technique of displaying a window having preset display colors when opening the window, following the startup of an application. Also, in the official gazette of the Japanese Unexamined Patent Publication No. H9-292871, there is disclosed a technique of performing the screen save control suitable for each type of the image display device being connected to the PC.

### SUMMARY OF THE INVENTION

However, a PC having a demonstration program installed therein is not always in a suitable condition for executing the demonstration program, though both sufficient hardware and software are implemented for performing the functions to be stressed through the demonstration program execution. For example, in order to demonstrate a TV view function by use of a TV tuner built in the PC, and also a TV view application program, it is necessary to prepare a cable connection from a TV-band radio wave receiving antenna to the TV tuner, as well as channel settings proper for each regional area on the TV view application program.

Assume a case that the demonstration program execution for stressing the TV view function is started without connecting the antenna cable or setting the channel settings. If the customer watching the demonstration becomes interested in the TV view function, and operates the actual PC product on display to use the TV view function by suspending the demonstration, only white-noise pattern or even nothing is displayed on the screen. This will reduce the customer's will to purchase, or undesirably lead the customer to misunderstanding or suspicion whether the TV view function is really usable.

In such a way, when there is a mismatch between the implemented condition of a certain function into the PC and the actual availability of the function, there is a problem of undesirably incurring misunderstanding or suspicion of customers who actually watch and touch the product at the store.

Accordingly, it is an object of the present invention to provide an installation program (installer) for use when installing a demonstration program for stressing a certain function in such a manner that the implemented condition in a PC matches actual availability of the function.

As a first aspect of the present invention, the aforementioned object is achieved by providing a program executed by a computer capable of executing a first program and a second program, including the steps of performing an execution decision procedure deciding whether the first program can be executed normally, and performing an installation procedure installing the second program when in the execution decision procedure the first program is decided to be executable normally.

As a second aspect of the present invention, in the first aspect, the first program records execution information into a storage unit of the computer at the time of execution, and the decision based on the execution information is performed in the execution decision procedure.

As a third aspect of the present invention, in the second aspect, the execution information is managed by the computer using an identifier.

As a fourth aspect of the present invention, in the second aspect, the first program is a TV view program.

As a fifth aspect of the present invention, in the fourth aspect, channel setting of the TV view program is recorded in the execution information, and whether the channel setting is set correctly is decided in the execution decision procedure.

As a sixth aspect of the present invention, in the first aspect, the second program is a demonstration program functioning as screen saver.

As a seventh aspect of the present invention, the aforementioned object is achieved by providing a method for installing a program. The method includes: in a computer capable of executing a first program and a second program, an execution decision procedure deciding whether the first program can be executed normally; and an installation procedure installing the second program when the first program is decided to be executable normally in the execution decision procedure.

As an eighth aspect of the present invention, in the seventh aspect, the first program records execution information into a storage unit of the computer at the time of execution, and the decision based on the execution information is performed in the execution decision procedure.

As a ninth aspect of the present invention, the aforementioned object is achieved by providing an information processing apparatus capable of executing a first program and a second program. The information processing apparatus includes: an execution decision section deciding whether the first program can be executed normally; and an installation section installing the second program when the execution decision section decides the first program can be executed normally.

As a tenth aspect of the present invention, in the ninth aspect, execution information is recorded at the time of executing the first program, and the execution decision section performs the decision based on the execution information.

Further scopes and features of the present invention will become more apparent by the following description of the embodiments with the accompanied drawings.

### BRIEF DESCRIPTION OF THE DRAWINGS

FIG. 1 shows a configuration diagram of an information processing apparatus 1 according to an embodiment of the present invention.

FIG. 2 shows an exemplary data structure of an installation table for each type.

FIG. 3 shows an exemplary data structure of an execution information reference table for each demonstration used for selecting a available demonstration program.

FIG. 4 shows an exemplary data structure of an installation list.

FIG. 5 shows a functional block diagram illustrating the control unit according to the embodiment of the present invention.

FIG. 6 shows a flowchart illustrating the operation of an information processing apparatus according to the embodiment of the present invention.

FIG. 7 shows a flowchart illustrating a step for deciding executability in detail, in the case of a TV function demonstration, as an example of the demonstration program.

### DETAILED DESCRIPTION OF THE INVENTION

The preferred embodiment of the present invention is described hereinafter referring to the charts and drawings. However, it is noted that the scope of the present invention is not limited to the embodiments described below.

In the embodiment of the present invention, a case of installing a plurality of demonstration program stored in a removable portable storage medium into an information processing apparatus will be described. Here, installation is a process of copying a program and/or data, necessary for the execution of a demonstration program, into a storage unit such as a hard disk. The installation also includes storing necessary settings for such as OS (operating system) which is basic control software for controlling the information processing apparatus into the storage unit.

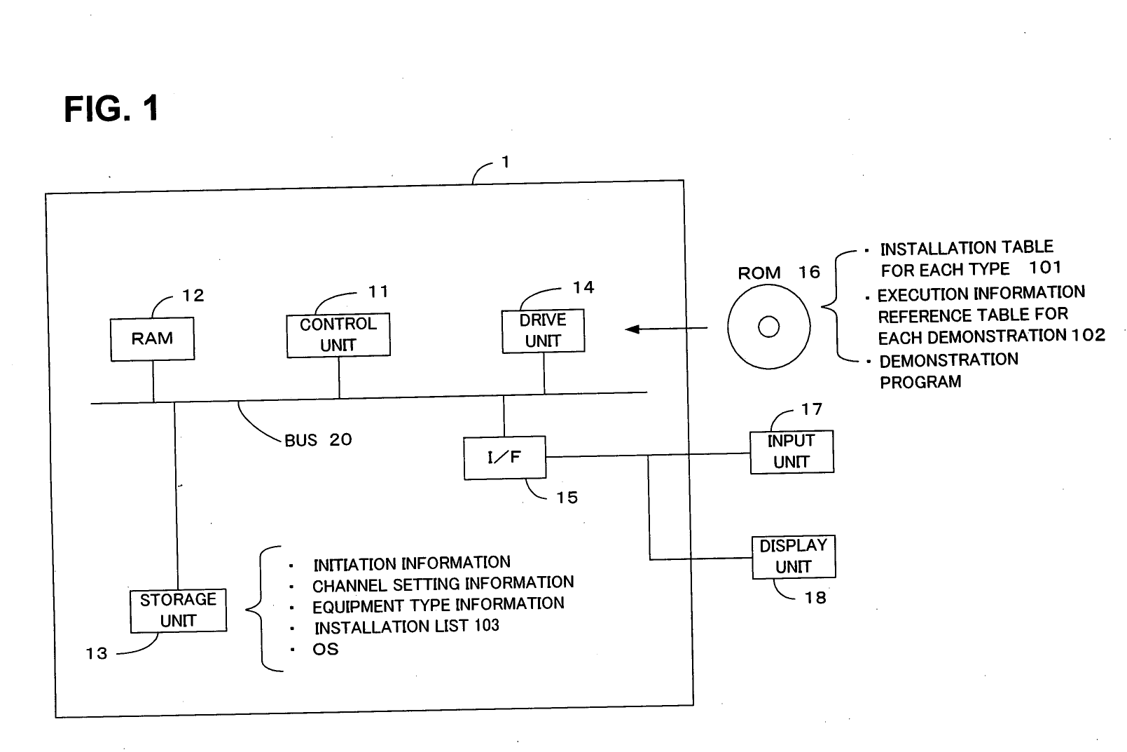

FIG. 1 shows a configuration diagram of an information processing apparatus 1 according to an embodiment of the present invention. Information processing apparatus 1 shown in FIG. 1 includes control unit 11, RAM (random access memory) 12, storage unit 13, and drive unit 14 such as floppy disk drive, CD (compact disk) drive, DVD (digital versatile disk) drive and MO (magneto-optical disk) drive, which are interconnected via a bus 20. Also, an input unit 17 and a display unit 18 are externally connected via an interface 15 for peripheral equipment connection connected to bus 20, with either wired or wireless connection.

In an exchangeable memory medium (ROM) 16 readable by drive unit 14, there are stored a plurality of demonstration programs to be installed into information processing apparatus 1; an installation table 101 for each equipment type, having each demonstration program combined with each equipment type of information processing apparatus 1; and an execution information reference table 102 for each demonstration, having hardware or software execution information (information storage location) in regard to each demonstration program to be installed from now on. Hardware execution information may include equipment configuration information specifying peripheral equipment of information processing apparatus 1, and the aforementioned equipment type information. Also, software execution information may include: initiation information generated when an application program is initiated, enabling confirmation of whether or not the program being initiated; attached information generated when a predetermined condition is satisfied after the initiation of the application program; and operation environment information settable and changeable from the OS, such as a screen resolution and audio volume.

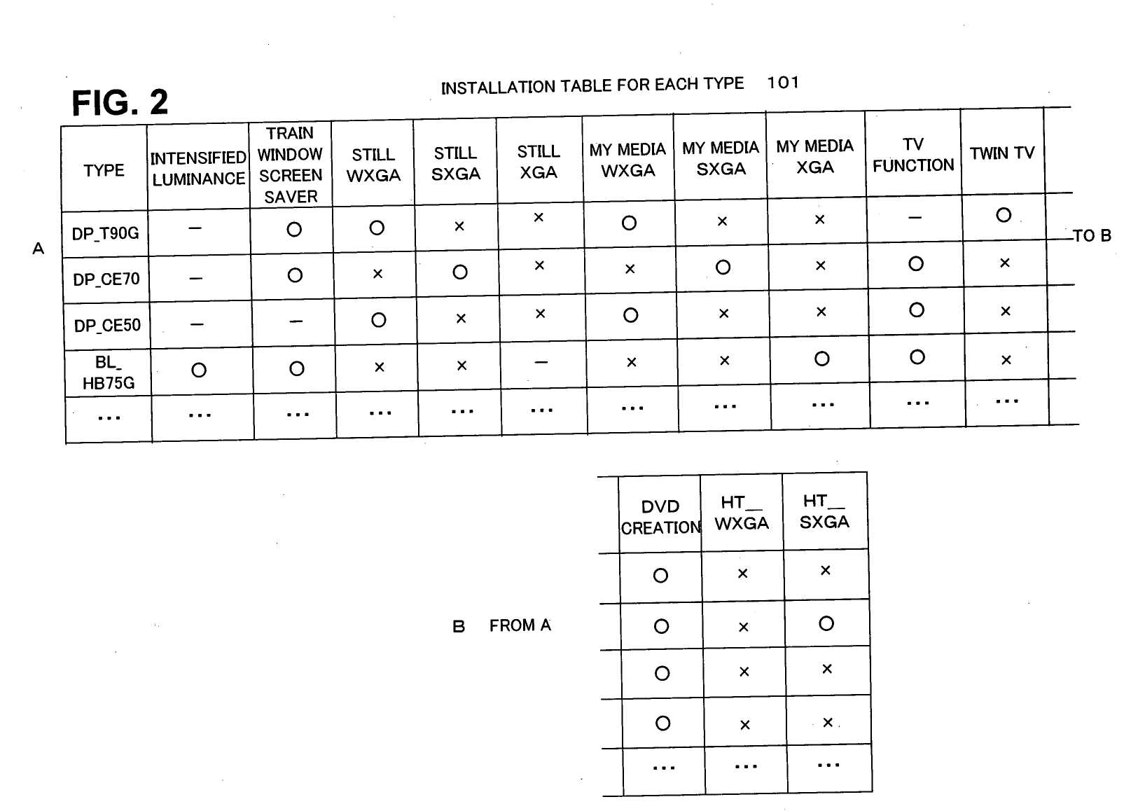

FIG. 2 shows an exemplary data structure of an installation table 101 for each type. In this installation table listed for each type shown in FIG. 2, a ‘type’ storing equipment type information that specifies the type of information processing apparatus 1 is stored. Also, an initial set value specifying whether or not the demonstration is to be installed is stored, on a basis of name for identifying each demonstration. As to ‘type’, type information is stored in the form of an identifier like ‘DP_T90G’, as model number representing the equipment type. In information processing apparatus 1, the aforementioned identifier specifying each equipment type is stored in advance in storage unit 13.

Demonstrations listed in FIG. 2 includes: ‘intensified luminance’ demonstration for stressing a high-luminance liquid crystal display being mounted; ‘train window screen saver’ demonstration for stressing a screen saver program, displaying changing scenery seen from a window of a running train; and ‘still WXGA’/‘still SXGA’/‘still XGA’ demonstration for stressing a fine liquid crystal by displaying as fine still images as possible corresponding to a resolution (WXGA, SXGA, XGA) of display unit; ‘MyMedia WXGA’/‘MyMedia SXGA’/‘MyMedia XGA’ demonstration for stressing on a resolution-by-resolution basis a ‘look-and-feel’ function, capable of controlling information processing apparatus 1 from a remote controller, like controlling home appliances. Other demonstrations include ‘TV function’ demonstration for stressing a TV view function using a built-in TV tuner; ‘twin TV’ demonstration for stressing a double-screen display function; ‘DVD creation’ demonstration for stressing recording capability of an original data onto a recordable DVD (DVD ±R/±RW, −RAM, etc.); ‘HT_WXGA’/‘HT_SXGA’ demonstration for stressing a technique of emulating two CPUs by use of a single CPU on a resolution-by-resolution basis.

Now, in FIG. 2, initial settings that specify whether or not a demonstration program is to be installed are depicted using three different marks. A mark ‘◯’ is indicative of being ‘recommended’ to install the demonstration program corresponding to the identifier. A mark ‘X’ is indicative of being ‘improper’ to install the demonstration program corresponding to the identifier. This ‘improper’ indication corresponds to a case such that the demonstration concerned is prepared for exhibiting a function that is not mounted on the equipment type. A hyphen ‘-’ is indicative of ‘to be decided by a sales section’, which means the decision is left to the related field sales section. Handling of the demonstration is varied individually, depending on the sales strategies formed for each equipment type or in each store.

In such a way, when the equipment type is specified, demonstration programs indicative of ‘recommended’ installation are selected as initial set. According to the embodiment of the present invention, an available demonstration program(s) is further selected among the initially selected demonstrations.

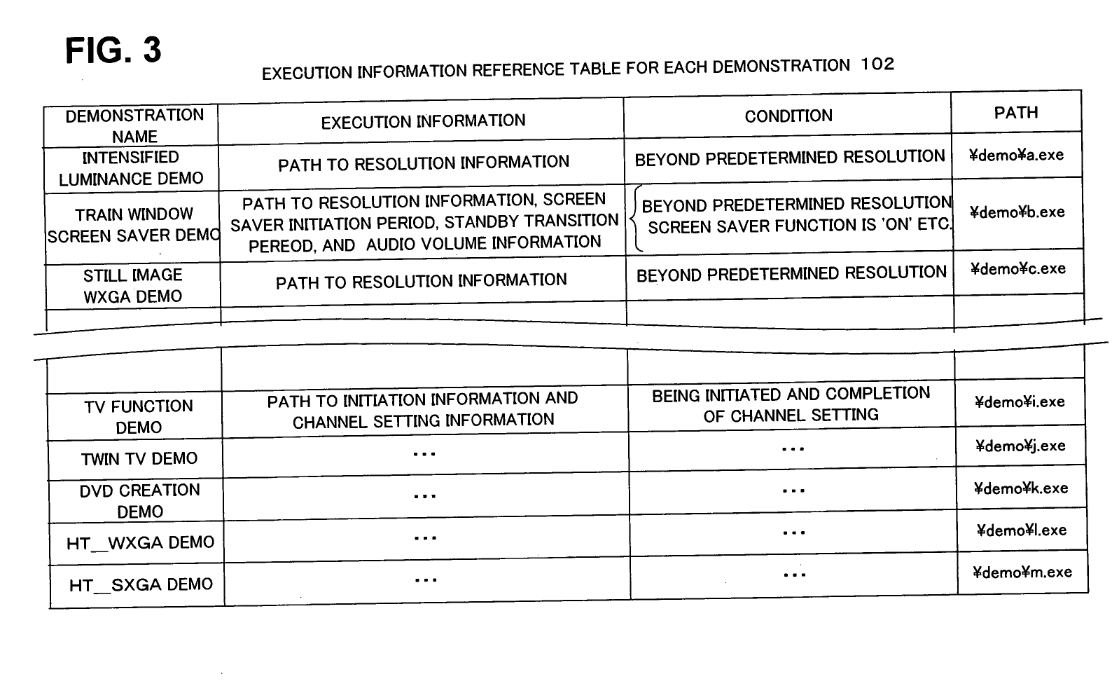

FIG. 3 shows an exemplary data structure of an execution information reference table 102 for each demonstration, which is used for selecting an available demonstration program(s). For each demonstration name identifying each demonstration, the following information is provided correspondingly: ‘execution information’ to be referred; ‘condition’ on which the demonstration is determined executable; and ‘path’ (access information) to a storage location in which the demonstration program concerned is stored. For example, in the case of the intensified luminance demonstration, executability of the demonstration is determined by referring to a path (access information to a file or a registry) to the resolution information that stores a present resolution and judging whether the present resolution has a predetermined resolution or higher.

In case of the train window screen saver demonstration, executability of the demonstration is determined by judging whether the ‘condition’ is satisfied, based on the resolution information; a screen saver initiation period, which specifies the period from a state of detecting no input signal to the information processing apparatus, to the time of initiating the screen saver; a standby transition period, which specifies a transit period to a standby mode in which less power is consumed; and audio volume information storing an audio volume set condition with which the sound is played during execution of the screen saver. For example, the conditions whether the display is set to a predetermined resolution or more, whether the screen saver function is not set to off, etc. are checked.

Also, in case of the TV function demonstration, executability of the demonstration is determined based on the correspondence between the initiation information storing whether the TV view application program is initiated and the channel setting information being generated on completion of channel setting after initiating the TV view application program. For example, in case of the TV view application program, as initiation information, when the OS is Windows (R), ‘execution information’ shown in FIG. 3 includes a path to a registry, such as the following:

HKEY_LOCAL_MACHINE¥Software¥company¥TVAppli¥ProgPath. Meanwhile, in case of the channel setting information, the ‘execution information’ shown in FIG. 3 includes a path to a registry, such as the following:

HKEY_LOCAL_MACHINE¥Software¥company¥TVAppli¥Version¥Chtbl¥1. For example, if the channel setting has been completed for a channel number ‘1’, a registry such as HKEY_LOCAL_MACHINE¥Software¥company¥TVAppli¥Version¥Chtbl¥1is existent. The number in the last digit is changed according to the change of the channel number, and by checking whether the corresponding number is existent, whether the channel setting has been completed can be determined.

Now, referring back to FIG. 1, storage unit 13 is a nonvolatile storage means such as hard disk, optical disk, magnetic disk, and flash memory. In storage unit 13, the following information is stored: execution information related to the hardware provided in information processing apparatus 1 and/or the software of which installation to information processing apparatus 1 has been completed (as an example, FIG. 1 depicts the initiation information and the channel setting information of the TV view application program that enable TV display in cooperation with the TV tuner provided in information processing apparatus 1); type information specifying the equipment type including a model number of the information processing apparatus, equipment type number, etc.; and an installation list 103 for identifying whether the demonstration program is to be installed.

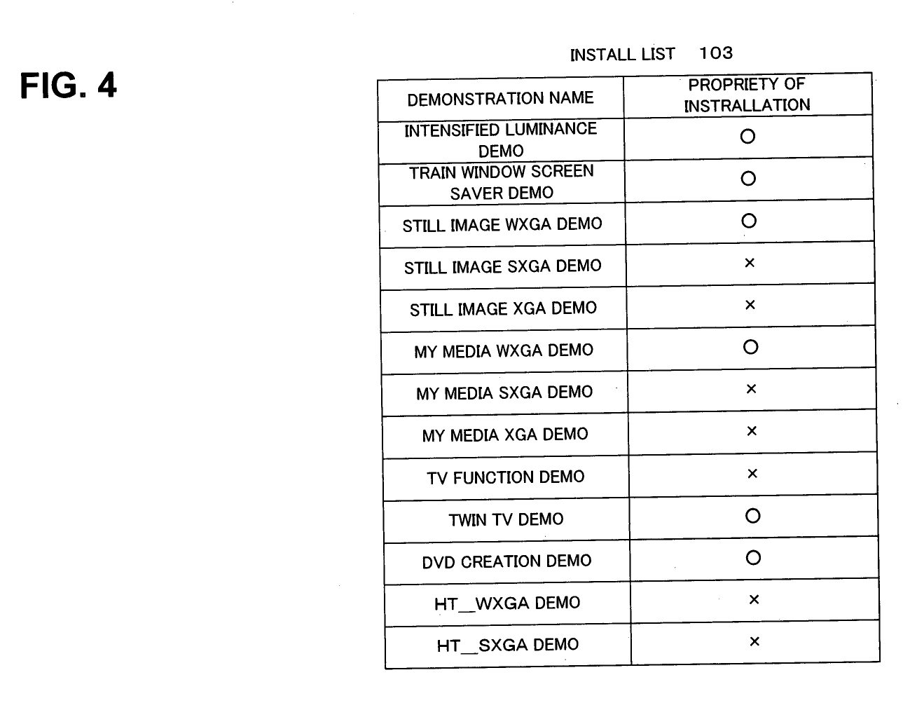

FIG. 4 shows an exemplary data structure of installation list 103. Installation list 103 is utilized to exclude non-executable demonstration program(s) from the list of demonstration programs initially selected from installation table 101 listed by type, according to each equipment type. In other words, if the entire demonstration programs are executable, then the contents of installation list 103 coincide with the contents of the demonstration program list initially selected.

As shown in FIG. 4, a data item named ‘propriety of installation’ indicative of whether the demonstration program corresponding to the demonstration name is to be installed or not is stored. Any demonstration program corresponding to the identifier shown as ‘◯’ in the ‘propriety of installation’ item is determined executable, and accordingly the program concerned is to be installed.

Referring back to FIG. 1, control unit 11 includes a non-illustrated CPU and controls information processing apparatus 1 by executing the OS or other programs stored in storage unit 13. RAM 12 is a memory means for temporarily storing operation results processed by control unit 11. Display unit 18 is a display device such as a liquid crystal display and a CRT display for displaying information to the user. Further, input unit 17 is an input device for inputting command signals input from the user through keyboard, mouse and power button, etc. into information processing apparatus 1.

Here, although not shown in FIG. 1, input unit 17 may be a network interface card (NIC), through which the information from other information processing apparatuses connected via a network may be input. According to the embodiment of the present invention, demonstration programs to be installed into information processing apparatus 1 are stored into an exchangeable memory medium, and provided therefrom. However, it may also be possible that a plurality of demonstration programs downloaded via the network are stored into a storage medium such as a hard disk, and provided therefrom.

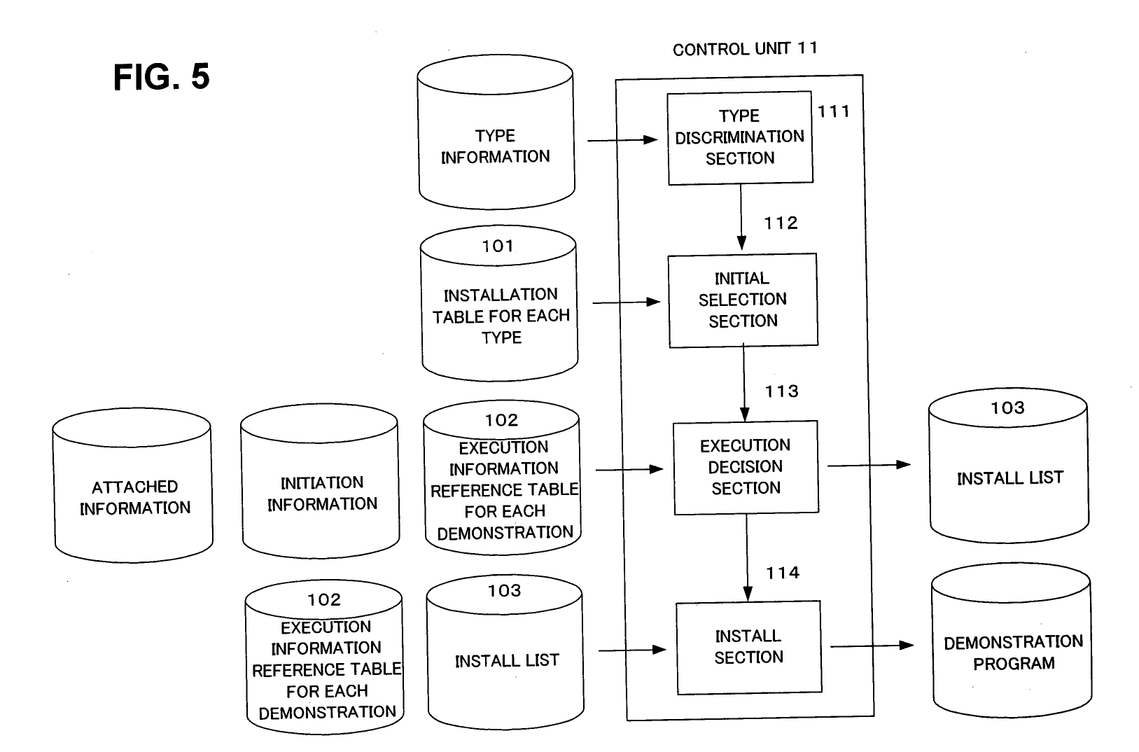

FIG. 5 shows a functional block diagram illustrating control unit 11 according to the embodiment of the present invention. Control unit 11 includes type discrimination section 111, initial selection section 112, execution decision section 113, and installation section 114. Type discrimination section 111 reads out type information from storage unit 13, identifies the equipment type of information processing apparatus 1, and supplies the identified equipment type to initial selection section 112.

Initial selection section 112 refers to installation table 101 for each type, identifies as initial selection a demonstration program(s) corresponding to the equipment type identified in type discrimination section 111, and supplies the identifier(s) to execution decision section 113. For example, according to FIG. 2, assuming that the identifier stored in the type information of information processing apparatus 1 is ‘BL_HB75G’, the following demonstrations are selected initially as ‘recommended’ demonstrations: ‘intensified luminance’, ‘train window screen saver’, ‘MyMedia XGA’, ‘TV function’ and ‘DVD creation’.

Execution decision section 113 refers to the execution information reference table for each demonstration, refers to the execution information corresponding to each identifier identifying the demonstration, determines whether the ‘conditions’ in the execution information reference table for each demonstration, and determines whether the demonstration program is executable. For example, in the case of the TV view application program, the initiation of application program is confirmed by whether the initiation information (HKEY_LOCAL_MACHINE¥Software¥company¥TVAppli¥ProgPath) is existent. Also, the completion of the channel setting is confirmed by whether the channel setting information (HKEY_LOCAL_MACHINE¥Software¥company¥TVAppli¥Version¥Chtbl¥1), which is the attached information generated when predetermined conditions (of channel setting completion) are satisfied after the initiation of the TV view application program. Then, according to the conditions shown in FIG. 3, if the initiation is confirmed, and further the channel setting is completed, it is determined the TV function demonstration is executable. Thus, installation of the corresponding demonstration program is performed.

Execution decision section 113 decides executability for each demonstration, and generates installation list 103 based on the above decision result. Execution decision section 113 decides that the demonstrations having been decided as executable among the demonstrations selected in initial selection section 112 are the demonstrations of which installation is to be executed (mark ‘◯’), while the demonstrations having been decided as non-executable are the demonstrations of which installation is not to be executed (mark ‘X’). Execution decision section 113 reflects above results into installation list 103, and informs installation section 114 of the generated installation list.

Installation section 114 determines the demonstration program(s) to be installed based on the generated installation list 103, and performs installation processing of the corresponding demonstration program(s), referring to the ‘path’ in execution information reference table 102 for each demonstration. Namely, installation section 114 copies the demonstration program and necessary data from ROM 16 to a predetermined area of storage unit 13, and performs necessary initial setting.

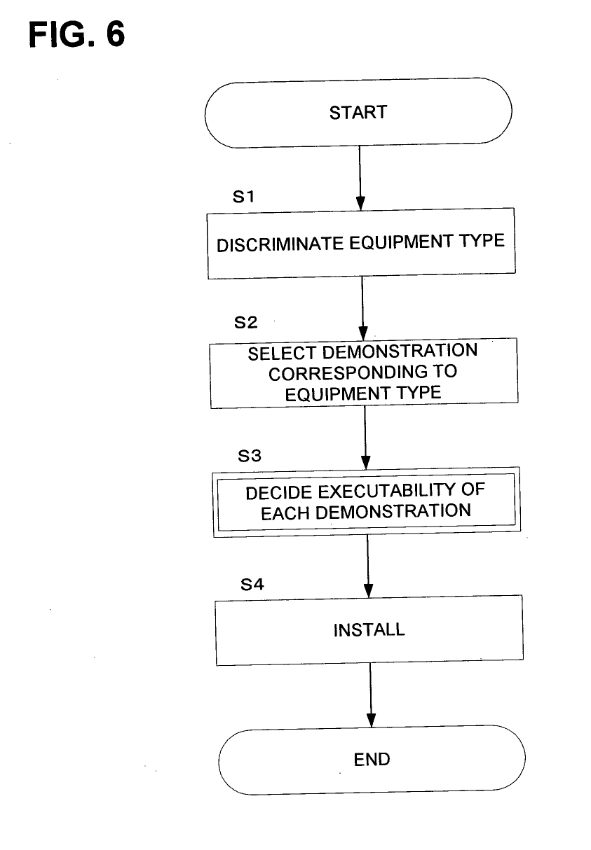

FIG. 6 shows a flowchart illustrating the operation of information processing apparatus 1 according to the embodiment of the present invention. First, type discrimination section 111 discriminates the equipment type (S1). On discriminating the equipment type, initial selection section 112 performs initial selection corresponding to the specified equipment type, based on installation table 101 for each type (S2).

Then, execution decision section 113 decides the executability of the demonstration for each demonstration selected in step S2, based on execution information reference table 102 for each demonstration, and generates installation list 103 that reflects the above decision result (S3). Finally, installation section 114 determines a demonstration program to be installed, based on installation list 103, and performs the installation processing of the demonstration program concerned (S4).

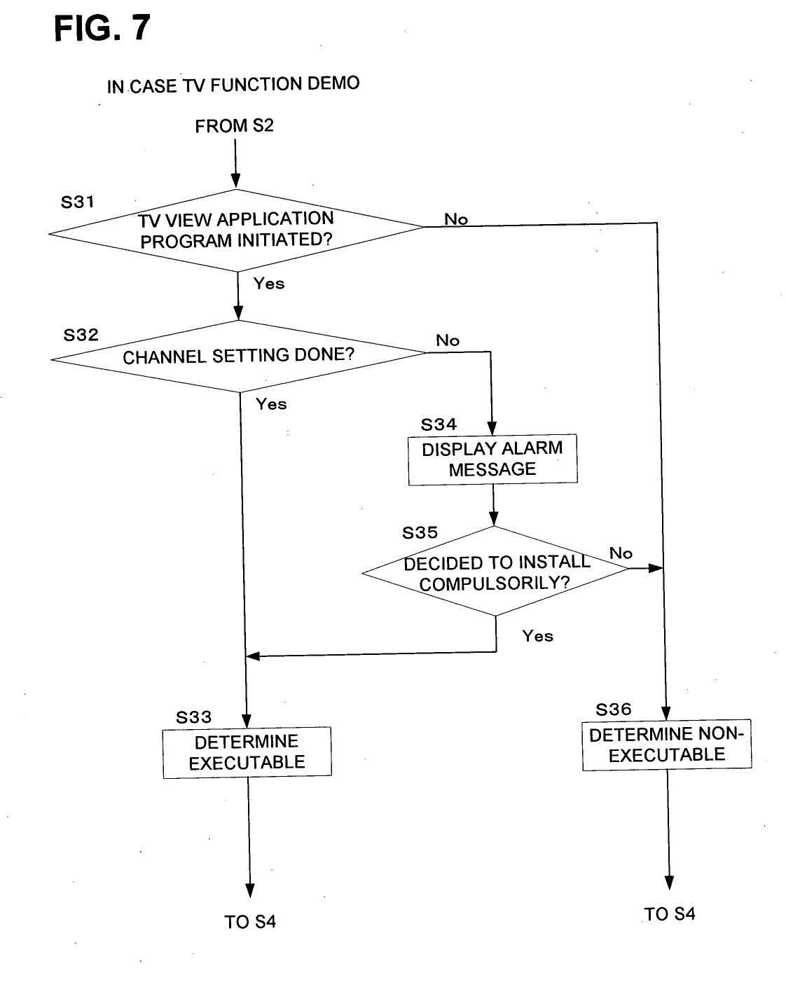

FIG. 7 shows a flowchart illustrating the executability decision step in detail, in the case of the TV function demonstration, as an example of the demonstration program. Here, it is assumed that an identifier (demonstration name) specifying an object demonstration for deciding the executability has been acquired in advance. Execution decision section 113 checks whether the TV view application program has been initiated (S31).

Execution decision section 113 refers to execution information reference table 102 for each demonstration, using the identifier having been acquired, and acquires a path to the initiation information, and then acquires the initiation information by accessing the path. For example, by executing an open command in a read mode against a registry key of HKEY_LOCAL_MACHINE¥Software¥company¥TVAppli¥ProgPath, if the registry can be opened normally, the completion of initiation is confirmed.

When the initiation is confirmed in step S31 (‘Yes’ in S31), then execution decision section 113 decides whether the channel setting has been completed (S32). Execution decision section 113 refers to execution information reference table 102 for each demonstration, acquires a path to the channel setting information, and then acquires the channel setting information. For example, by executing an open command in a read mode against a registry key of HKEY_LOCAL_MACHINE¥Software¥company¥TVAppli¥Version¥Chtbl¥1, execution decision section 113 reads in a data defined as ChannelTune, which is a set value related to the TV tuner. If this value can be read out normally, and further if this value is other than zero, it can be decided that the channel setting has been completed for the channel number. The last digit of the aforementioned registry key corresponds to the channel number. Execution decision section 113 performs the above decision for necessary channels, and decides whether the channel setting has been completed for the channel concerned.

In step S32, on determination that the channel setting has been completed (‘Yes’ in S32), execution decision section 113 determines that the demonstration program for stressing the TV view function is executable. Execution decision section 113 then updates the ‘propriety of installation’ item corresponding to the TV function demonstration in the installation list shown in FIG. 4 with the information indicative of installation execution (represented by the mark ‘◯’ in FIG. 4).

In step S31, if initiation of the TV view application program is not confirmed (‘No’ in S31), execution decision section 113 determines that the corresponding demonstration program is non-executable. Execution decision section 113 then updates the ‘propriety of installation’ item corresponding to the TV function demonstration in the installation list by the information indicative of non-execution of installation (represented by the mark ‘X’ in FIG. 4) (S36). In step S32, when the channel setting is not completed while the initiation of the TV view application program is confirmed (‘No’ in S32), an alarm message that the channel setting is not completed is displayed (S34), and execution decision section 113 decides whether the demonstration program is to be installed compulsorily (S35). For example, execution decision section 113 displays the alarm message in step S34, and at the same time, inquires of the user whether to perform compulsory installation by displaying a screen that urges the user to input a choice, and then receives an input from the user. If the input signal signifies consent to the compulsory installation (‘Yes’ in S35), the process proceeds to step S33, and thereafter the TV function demonstration program is executed. Otherwise, if the input signal signifies disagreement to the compulsory installation (‘No’ in S35), execution decision section 113 decides the program is not executable (S36). Here, the decision in the step S35 is not necessarily based on the signal input from the user. The decision may be based on flag information stored in advance in the storage unit, which is indicative of permission/non-permission of the compulsory installation. Such execution decision is performed for each demonstration in a similar way to that shown in FIG. 7, and installation list 103 is generated depending on the decision result of being executable (S33) or non-executable (S36). The process then proceeds to step S4, in which installation section 114 performs installation based on installation list 103.

As the embodiment of the present invention has been described, according to the embodiment, it becomes possible to install into an information processing apparatus a demonstration program for properly stressing a function which is implemented in the information processing apparatus (for example, PC) and also available, to the customer. Thus, the user becomes interested in the demonstration presented through the execution of the demonstration program, and can use the function being demonstrated correctly when operating the actual product. This eases customer's mind and improves customer's reliance on the product. Also, it becomes possible to prevent decline of purchase will that may occur conventionally.

The aforementioned effects can also be obtained when the operation of the information processing apparatus is actualized in the form of either an installation method or a program that processes the function provided in the control unit.

The foregoing description of the embodiments is not intended to limit the invention to the particular details of the examples illustrated. Any suitable modification and equivalents may be resorted to the scope of the invention. All features and advantages of the invention falling within the scope of the invention are covered by the appended claims.

1. A program executed by a computer capable of executing a first program and a second program, comprising the steps of:
performing an execution decision procedure deciding whether the first program can be executed normally; and
performing an installation procedure installing the second program when in the execution decision procedure the first program is decided to be executable normally.

2. The program according to claim 1,
wherein the first program records execution information into a storage unit of the computer at the time of execution, and the decision based on the execution information is performed in the execution decision procedure.

3. The program according to claim 2,
wherein the execution information is managed by the computer using an identifier.

4. The program according to claim 2,
wherein the first program is a TV view program.

5. The program according to claim 4,
wherein channel setting of the TV view program is recorded in the execution information, and whether the channel setting is set correctly is decided in the execution decision procedure.

6. The program according to claim 1,
wherein the second program is a demonstration program functioning as screen saver.

7. In a computer capable of executing a first program and a second program, a method for installing a program comprising:
an execution decision procedure deciding whether the first program can be executed normally; and
an installation procedure installing the second program when the first program is decided to be executable normally in the execution decision procedure.

8. The installation method according to claim 7,
wherein the first program records execution information into a storage unit of the computer at the time of execution, and the decision based on the execution information is performed in the execution decision procedure.

9. The installation method according to claim 8,
wherein the execution information is managed by the computer using an identifier.

10. The installation method according to claim 8,
wherein the first program is a TV view program.

11. The installation method according to claim 10,
wherein channel setting of the TV view program is recorded in the execution information, and whether the channel setting is set correctly is decided in the execution decision procedure.

12. The installation method according to claim 7,
wherein the second program is a demonstration program functioning as screen saver.

13. An information processing apparatus capable of executing a first program and a second program, comprising:
an execution decision section deciding whether the first program can be executed normally; and
an installation section installing the second program when the execution decision section decides the first program can be executed normally.

14. The information processing apparatus according to claim 13,
wherein execution information is recorded at the time of executing the first program, and the execution decision section performs the decision based on the execution information.

15. The information processing apparatus according to claim 14,
wherein the execution information is managed by the information processing apparatus using an identifier.

16. The information processing apparatus according to claim 14,
wherein the first program is a TV view program.

17. The information processing apparatus according to claim 16,
wherein channel setting of the TV view program is recorded in the execution information, and the execution decision section decides whether the channel setting is set correctly.

18. The information processing apparatus according to claim 13,
wherein the second program is a demonstration program functioning as screen saver.
